(19) United States
(12) Patent Application Publication
(10) Pub. No.: US 2004/0080818 A1
(43) Pub. Date: Apr. 29, 2004

(54) Microscope system and method for detecting and compensating for changes in a recorded image content

(75) Inventor: Frank Olschewski, Heidelberg (DE)

Correspondence Address: HOUSTON ELISEEVA, 4 MILITIA DRIVE, SUITE 4, LEXINGTON, MA, 02421, US

(73) Assignee: Leica Microsystems Heidelberg GmbH, Mannheim (DE)

(21) Appl. No.: 10/685,072

(22) Filed: Oct. 14, 2003

(30) Foreign Application Priority Data
Oct. 29, 2002 (DE) DE 102 50 503.9

(51) Int. Cl. G02B 21/26

(52) U.S. Cl. 359/391

(57) ABSTRACT

A microscope system for detecting and compensating for changes within a recorded image content of a microscopic specimen is disclosed. A means for calculating signatures of a recorded multidimensional image (50) is provided. A means for calculating statistical signature parameters is also provided. Multiple positioning motors and/or actuators on the microscope receive from the software module control signals that can be ascertained from the signature parameters.

### RELATED APPLICATIONS

This application claims priority of the German patent application 102 50 503.9 which is incorporated by reference herein.

### FIELD OF THE INVENTION

The invention concerns a microscope system for detecting and compensating for changes in a recorded image content of a microscopic specimen.

The invention further concerns a method for detecting and compensating for changes in a recorded image content of a microscope specimen using a microscope.

### SUMMARY OF THE INVENTION

It is the object of the invention to create a microscope system with which changes in an image content can be monitored and determined in quick and reliable fashion, and on the basis of which the microscope system is readjusted.

This object is achieved by way of a microscope system for detecting and compensating for changes within a recorded image content of a microscopic specimen comprising: a microscope that defines an illuminating light beam and a detected light beam, at least one objective, an XYZ stage, a scanning module, a detector module having at least one detector, and a computer system which has a means for calculating signatures of a recorded multidimensional image and a means for calculating statistical signature parameters; multiple positioning motors and actuators are provided on the microscope; and at least one software module, which supplies to the positioning motors or actuators control signals that can be ascertained from the signature parameters.

A further object of the invention is to create a method with which changes in an image content can be monitored and determined in quick and reliable fashion, and on the basis of which the microscope system is readjusted.

The aforesaid object is achieved by way of a method for detecting and compensating for changes within a recorded image content of a microscope specimen using a microscope, comprising the steps of:

a) scanning a specimen with an illuminating light beam and recording multiple image points for generation of a multidimensional image;

b) calculating signatures of the recorded multidimensional image;

c) calculating statistical signature parameters from the recorded signatures;

d) observing and ascertaining the changes in the statistical signature parameters; and

e) interpreting the changes in the signatures and converting them into signals for positioning motors or actuators that are provided in the microscope system.

The invention has the advantage that a computer system is provided which determines the calculation of statistical signatures of a recorded multi-dimensional image. These signatures result from projection of the grayscale values based on the inherent axes of the image (X, Y, Z, lambda). In addition, a means for calculating statistical signature parameters is provided. It is especially advantageous that several positioning motors and/or actuators are provided on or in the microscope system, and that at least one software module is implemented that supplies to the positioning motors or actuators control signals which can be ascertained from the signature parameters. It is thereby possible to guarantee that, for example, a specimen element that is to be observed is always in the optimum image window regardless of its motion. A corresponding displacement of the XYZ stage is then performed for this purpose, the positioning signals being derived from the statistical signatures and the statistical parameters. It is likewise conceivable for the wavelength of the fluorescent light proceeding from an element of the specimen to change. A suitable displacement at the SP module of the microscope system would be necessary for this purpose.

Further advantageous embodiments of the invention are evident from the dependent claims.

### BRIEF DESCRIPTION OF THE DRAWINGS

The subject matter of the invention is schematically depicted in the drawings and will be described below with reference to the Figures, in which:

FIG. 1 schematically depicts a scanning microscope, the detectors being preceded by an SP module;

FIG. 2 schematically depicts the scanning of a region of a sample;

FIG. 3 graphically depicts a projection of the intensity values each having identical coefficients of a coordinate;

FIG. 4 graphically depicts projections, at different times, of the intensity values each having identical coefficients of a coordinate;

FIG. 5 explains the principle of inference; and

FIG. 6 schematically depicts the connections of the computer system to positioning elements of the scanning microscope.

### DETAILED DESCRIPTION OF THE INVENTION

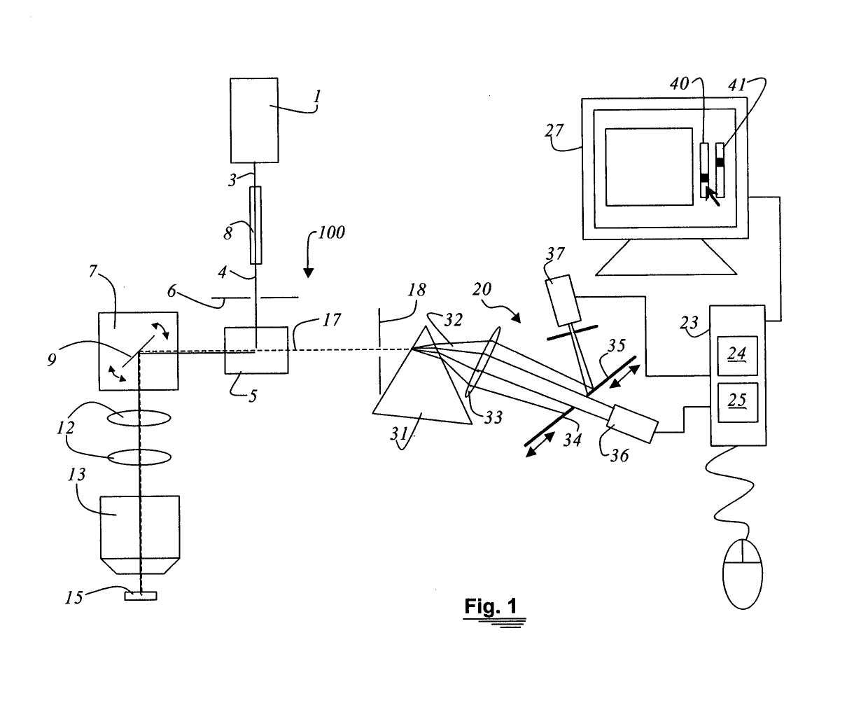

FIG. 1 schematically shows an exemplary embodiment of a confocal scanning microscope 100. This is not intended, however, to be construed as a limitation of the invention. Illuminating light beam 3 coming from at least one illumination system 1 is directed by a beam splitter or a suitable deflection means 5 to a scanning module 7. Before illuminating light beam 3 strikes deflection means 5, it passes through an illumination pinhole 6. Scanning module 7 encompasses a gimbal-mounted scanning mirror 9 that guides illuminating light beam 3, through a scanning optical system 12 and a microscope optical system 13, over or through a specimen 15. Illumination system 1 can be configured in such a way that it generates white light from the light of a laser 10. A microstructured element 8 or a tapered glass fiber is provided for this purpose. For biological specimens 15 (preparations) or transparent specimens, illuminating light beam 3 can also be guided through specimen 15. For these purposes, non-luminous specimens are, if applicable, prepared with a suitable dye and often also with several dyes (not depicted, since established existing art). The dyes present in specimen 15 are excited by illuminating light beam 3 and emit light in a characteristic region of the spectrum peculiar to them. This light proceeding from specimen 15 defines a detected light beam 17. Detected light beam 17 travels to a detector module 22. Detected light beam 17 travels through microscope optical system 13 and scanning optical system 12 and via scanning module 7 to deflection means 5, passes through the latter, and travels to detector module 22. Through a detection pinhole 18, it strikes at least one detector 36, 37 embodied respectively as a photomultiplier. It is evident to one skilled in the art that other detection components, for example diodes, diode arrays, photomultiplier arrays, CCD chips, or CMOS image sensors, can also be used. Detected light beam 17 proceeding from or defined by specimen 15 is depicted in FIG. 1 as a dashed line. In detectors 36, 37, electrical detected signals proportional to the power level of the light proceeding from specimen 15 are generated. Since, as already mentioned above, light of not only one wavelength is emitted from specimen 15, it is useful to provide an SP module 20 in front of the at least one detector 36, 37. The data generated by the at least one detector 36, 37 are delivered to a computer system 23. At least one peripheral 27 is associated with computer system 23. Peripheral 27 can be, for example, a display on which the user receives instructions for setting scanning microscope 100, or can view the current setup and also the image data in graphical form. Also associated with computer system 23 is an input means 28 that comprises, for example, a keyboard, an adjusting apparatus for the components of the microscope system, and/or a mouse 30. A memory 24, in which the signatures are stored as data sets, is likewise associated with computer system 23. Additionally implemented in computer system 23 is a software program 25 with which the appropriate calculations for the method according to the invention can be carried out. Setting elements 40, 41 for image recording are additionally depicted on display 27. In the embodiment shown here, setting elements 40, 41 are depicted as sliders. Setting elements 40, 41 can also be embodied as check boxes which make possible yes/no activation for specific parameters. Any other embodiment lies within the specialized ability of one skilled in the art.

Detected light beam 17 is spatially spectrally divided using a prism 31. A further possibility for spectral division is the use of a reflection or transmission grating. The spectrally divided light fan 32 is focused with focusing optical system 33 and then strikes a mirror stop arrangement 34, 35. Mirror stop arrangement 34, 35; the means for spectral spatial division; focusing optical system 33; and detectors 36 and 37 are together referred to as SP module 20 (or the multi-band detector).

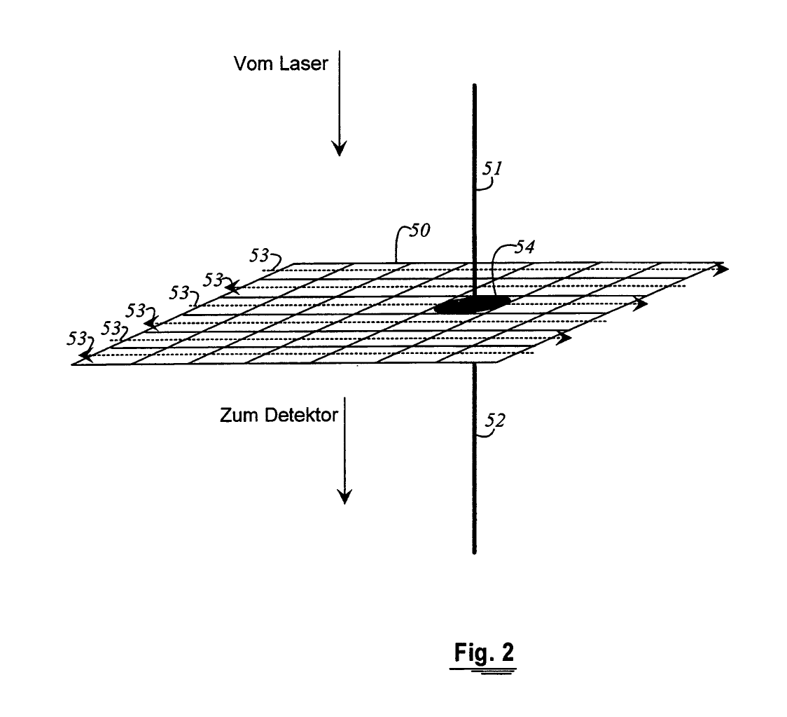

Images 50 of specimens 15 can be recorded with the microscope system described in FIG. 1. Images 50 are, as a rule, constructed from a two-dimensional matrix of serially arranged image points 54. Higher-dimensional images can also be acquired by way of an action appropriately coordinated by the control computer. FIG. 2 schematically depicts image recording. Image recording with the microscope system usually proceeds in such a way that one plane in specimen 15 is illuminated point by point (or pixel by pixel) using a laser beam 51. Detection of detected light 52 proceeding from specimen 15 is also accomplished on a point-by-point or pixel-by-pixel basis. The region of specimen 15 which is to be recorded as an image, or whose data are to be registered, can be modified in suitable fashion by the user. For example, the user can limit the size to certain regions of interest of specimen 15. The sample or specimen is scanned by laser beam 51, usually in meander fashion. Laser beam 51 is scanned along arrows 53 indicated in FIG. 2. The gray-shaded circle shown in FIG. 2 represents the planar image point 54 with which the entire sample is scanned. The exemplary embodiment shown in FIG. 2 depicts a non-descan configuration, so that light transmitted by and proceeding from the specimen is detected. Depending on the settings of the microscope system or the user's stipulations, the wavelength, intensity, etc. can be determined for each scanned image point. The dimensionality of the image created of the sample is thus obtained based on the number of values determined. The recorded data are transferred to computer system 23 for a specific evaluation that is selectable by the user.

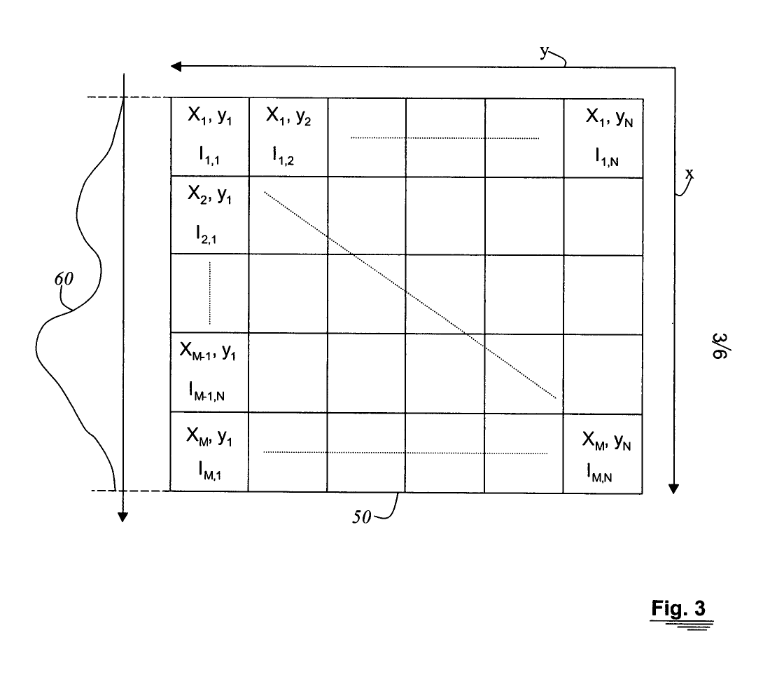

As already mentioned above, the recorded image can be two-dimensional, three-dimensional, four-dimensional, etc. depending on the measurement method selected. A three-dimensional image comprises, for example, the X coordinate x_{M}, the Y coordinate y_{N}, and an intensity I_{MN} for the intensity measured at the particular pixel. It is self-evident that the image of specimen 15 can be assembled from multiple degrees of freedom of the system (e.g. X, Y, Z, wavelength, intensity, etc.). The degrees of freedom are referred to as axes of the image. FIG. 3 depicts a three-dimensional image reproducing the X axis x, Y axis y, and intensity I at each pixel x_{M}, y_{N}. A projection can be calculated for the schematic depiction of the image in FIG. 3; in other words, for example, for all discrete coordinates of the X axis, all pixels of the image that have the same coefficient for that coordinate are totaled. The sum of all intensities is therefore created. This yields a distribution function 60 that says something about the compactness of the image scene. This calculation step can be performed efficiently, for example, by means of FPGAs or DSPs. This distribution function 60 can be described relatively easily using descriptive statistical parameters, for example mean, variance, higher statistical moments, minimum and maximum, median, or statistical quartiles. Any parameter for the description of statistical distributions and distribution density functions can be used, in this context, to quantify changes. If the variance on X axis x changes between images this means, if the variance becomes smaller, a concentration of pixels, which is an indication to make the image format smaller; if it becomes greater, this is an indication to enlarge the image format. If the mean or one of the boundary quartiles changes, this is an indication that a moving specimen is present. If the variance remains unchanged (within certain limits), a moving object is often present. The same method or classification can also be used for the Y axis and Z axis. It should be noted in this context that a great many different arguments and control protocols can be constructed from different statistical parameters. This topic will be returned to later when inference is discussed.

The interpretation is slightly different in the spectral case, since spectral changes occur on the basis of chemical and physical parameters, which are somewhat more difficult to grasp mentally. In principle, however, the increase and reduction of the image format (spectral scan points) is identical.

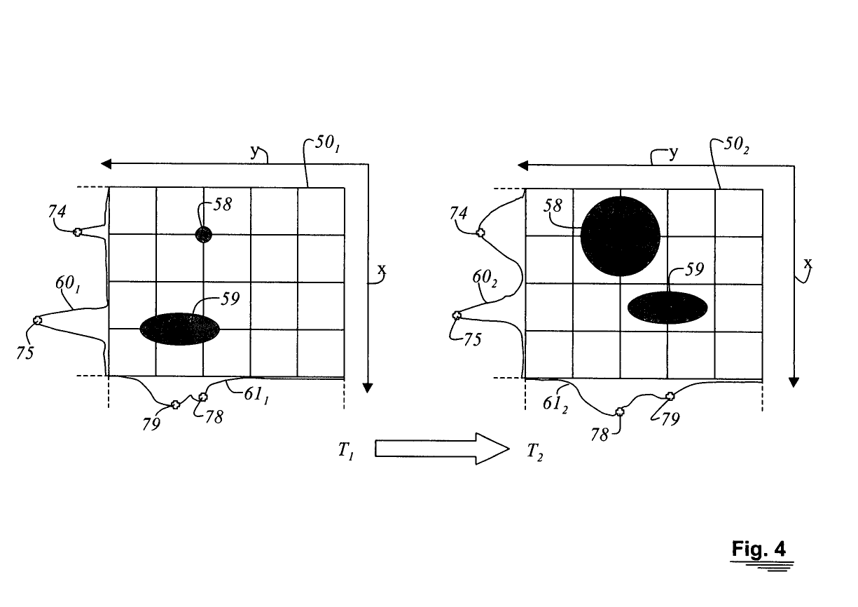

FIG. 4 graphically depicts projections, at different times, of intensity values each having identical coefficients of a coordinate. At a time T₁, image 50₁ of specimen 15 is recorded, and distribution function 60₁ referring to X axis x, and a distribution function 61₁ referring to the Y axis, are ascertained. Specimen 15 contains, for example a first and a second element 58, 59. In distribution function 60, referring to the X axis, locations 74, 75 of first and second element 58, 59 are ascertained. In distribution function 61₁ referring to the Y axis, locations 77, 78 of first and second element 58, 59 are likewise ascertained. At a time T₂, image 50₂ of specimen 15 is recorded, and distribution function 60₂ referring to X axis x, and a distribution function 61₂ referring to the Y axis, are determined. For first and second element 58, 59 present in specimen 15, locations 74, 75 of first and second element 58, 59 with reference to the X axis are ascertained from distribution function 60₂. Similarly, the locations 78, 79 of first and second element 58, 59 with reference to the Y axis are ascertained from distribution function 61₂. From a comparison of locations 74, 75, 78, and 79, conclusions can be drawn as to the changes in first and second element 58, 59. In the example depicted in FIG. 4, for element 58 there is an increase in size with no change in location. For second element 59, a change in location is determined. Scanning microscope 100 can now be adjusted correspondingly for second element 59 so that element 59 is always at the center of an image window (not depicted).

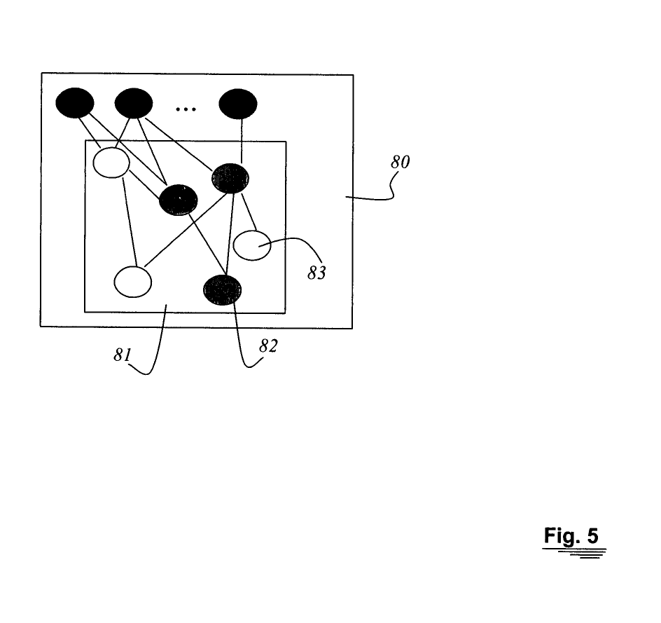

FIG. 5 illustrates the principle of inference. Inference is a mechanism for systematically deriving conclusions from a set of rules. The principle of inference via knowledge of facts has been standard for some time in artificial intelligence (AI); in it, a sequence of facts and rules of the form

A

B

IF A THEN B

IF C THEN E

. . .

IF A AND C THEN D OR F

is processed. In these rules, variable and facts (in this case A, B, C, D, E, F) are logical statements that can be examined. All the rules are arranged in a database in the computer memory, and are processed using backtracking algorithms. The facts are entered in a list (e.g. “A is true”), all the rules are checked, and new facts are generated using the rule set, until no further facts are generated by another pass. For example, the rule (IF XX THEN YY) is true if the premise XX occurs, and thus becomes a new fact. This concept can be applied directly if the appropriate set of features is present in appropriately coded fashion. For that purpose, the signature parameters are embedded in a fact and rule base which might look something like this:

VARIANCE_STABLE=(abs(var1-var2)<epsilon)

MEAN_STABLE=(abs(mean1-mean2)<epsilon)

IF VARIANCE_STABLE AND MEAN_STABLE

THEN NO_MOTION

IF (var2>var1 AND MEAN_STABLE) THEN EXPANSION

IF (mean2>mean1 AND VARIANCE_STABLE) THEN MOTION

A handful of rules thus already allows the data to yield a relatively simple interpretation such as “motion,” “contraction,” or “expansion.” This requires, of course, that the rule base be constructed for the multidimensional case, which would go well beyond the context of this presentation. If a statement is constructed iteratively, the inference machine can perform increasingly detailed evaluations, the type of evaluation being defined explicitly by the stored rule mechanism which, if the statements are sufficiently fine-scale, can quickly assume substantial dimensions. The performance of the system depends only on the number and quality of the rules, the initial facts made available, and the accuracy with which those facts are measured, and thus permits a great many degrees of freedom for implementation. It remains to note that this is an extremely powerful calculation tool which, in terms of information theory, can calculate anything that is calculable. The simplicity of these examples serves merely to make the actual process transparent. A suitable implementation will result in far longer inference chains that would, however, go well beyond the context of this presentation. Based on the situation classification arrived at by inference, the control loop can then be effectively closed by adding further facts such as

MOTION_CONTROL_SIGNAL_X=a*(mean2−mean1)

and rules such as

IF MOTION_X

THEN SET X MOTION_CONTROL_SIGNAL_X.

It remains to that even the more recent variants of the basic inference idea, such as fuzzy control, neuro-fuzzy control, Bayes networks, etc., change nothing in terms of the principle but simply generate soft and continuous statements using the rule base, instead of the hard decision boundaries defined by Boolean logic. In these approaches, the time-honored logic elements AND, OR, NOT, IF, THEN, etc. are explicitly or implicitly replaced by softer equivalents. In the case of approaches based on probability theory such as Bayes, the rules have a probability assigned to them by the rule mechanism, those rules with maximum probability being selected. This is sufficiently familiar to one skilled in the art and may be advantageous in the context of an implementation without contradicting the teaching of this invention. The possibility also exists of constructing the inference machine directly as a computer program in code. In the system, individual rules 81 are iteratively picked out from the set of all rules and facts 80, and their premises are tested. Because of the iterative embodiment, at runtime the method therefore generates a tree of rules having confirmed premises 82, which can be interpreted as an argumentation or proof. The process continues until no further rules are proven and derivable control signals are present.

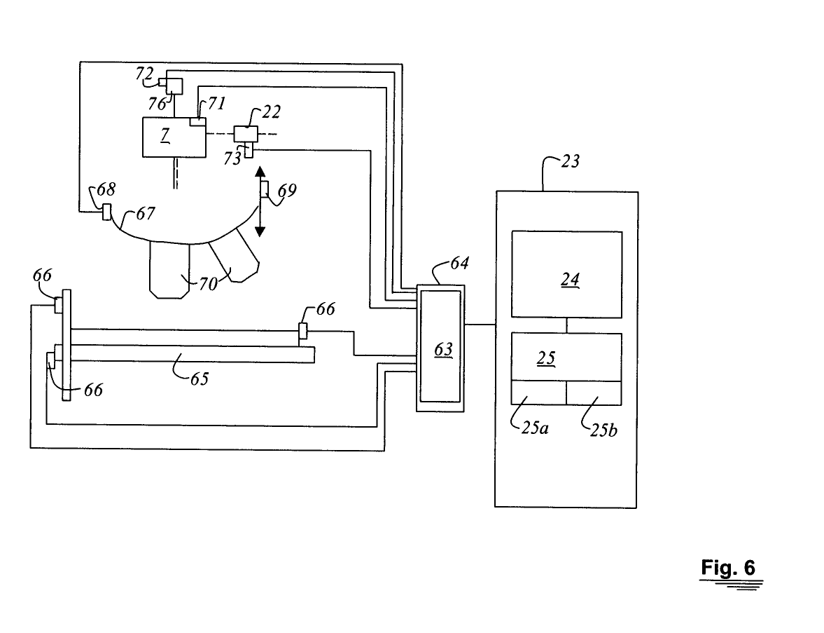

FIG. 6 schematically depicts a portion of a microscope system that shows the connection between computer system 23 and the various positioning elements of scanning microscope 100. In an embodiment, for example, an FPGA 63 which performs the calculation of spectral signatures for each axis can be provided. FPGA 63 can be arranged in the microscope itself, or can be housed in a separate electronics box 64 provided for it, or embodied as a plug-in module in the computer itself. In the exemplary embodiment depicted in FIG. 4, FPGA 63 is housed in an electronics box 64. It is also conceivable to perform for each axis a calculation of the spectral signatures that is implemented in software. Both software program 25 and/or FPGA 63 can coact in appropriate fashion. A calculation of statistical signature parameters implemented in software program 25/FPGA 63 is implemented. Also provided is a software module 25a that serves to track changes in the signatures. A further software module 25b serves to interpret the change and convert it into corresponding actuator signals. For example, scanning microscope 100 is equipped with an XYZ stage 65 that is configured to be displaceable in all three spatial directions. A positioning motor, with which a suitable displacement of XYZ stage 65 is performed, is provided for each axis. The signals for displacement are generated by further software module 25b. Further software module 25b also generates signals for displacing an objective turret 67 of scanning microscope 100. Objective turret 67 encompasses a first positioning motor 68 to rotate objective turret 67, so that one of the several objectives 70 is brought into the working position. A second positioning motor or actuator 69 (piezo) that produces a relative motion between objective turret 67 and XYZ stage 65 can additionally be provided. Selection of a different objective 70 is activated, for example, if the result of the calculations by software modules 25a and 25b necessitates selection of a new image window. Appropriate control signals are also supplied to galvanometers 71 of scanning module 7. A detector module 22 is likewise adjustable by way of at least one suitable positioning element 73 in accordance with stipulations made by the user and/or at least one of software modules 25a or 25b. A further displacement possibility exists by way of suitable adjustment of the illuminating light. A positioning means 72 that actuates a selection means 76 in order to select a specific spectral region of a spectral illumination is provided for this purpose. The number of actuation possibilities depends substantially on the way in which the microscope system is equipped. A standard configuration of a scanning microscope often also has, for example, an XY stage and a coarse Z actuator in addition to an XYZ galvanometer control system for controlling the scanning point, resulting in two sets of actuators for X, Y and Z, respectively, that can be used for control purposes. The exact embodiment in terms of when a particular actuator is controlled is left to the ability of one skilled in the art, who selects the control base in such a way that large displacement travels are compensated for with the coarse actuator, and small displacement travels with the fine actuator. It remains to note that a compensation for spectral changes makes sense only in a system that is equipped with an adjustable spectral detector. In general, any degree of freedom in an XYZ-lambda context can thus be compensated for, provided the microscope configuration has actuators for that degree of freedom.

While this invention has been particularly shown and described with references to preferred embodiments thereof, it will be understood by those skilled in the art that various changes in form and details may be made therein without departing from the scope of the invention encompassed by the appended claims.

What is claimed is:

1. A microscope system for detecting and compensating for changes within a recorded image content of a microscopic specimen comprising: a microscope that defines an illuminating light beam and a detected light beam, at least one objective, an XYZ stage, a scanning module, a detector module having at least one detector, and a computer system which has a means for calculating signatures of a recorded multidimensional image and a means for calculating statistical signature parameters; multiple positioning motors and actuators are provided on the microscope; and at least one software module, which supplies to the positioning motors or actuators control signals that can be ascertained from the signature parameters.

2. The microscope system as defined in claim 1, wherein the software module records and observes changes in the signatures, derives signature parameters, and ascertains control signals from the signature parameters on the basis of an inference method.

3. The microscope system as defined in claim 1, wherein changes in scan parameters can be determined from the ascertained signature parameters; and the scan parameters encompass the image format, position of the XYZ stage, electronic zoom, objective change, galvanometer positions, and spectral scan bands.

4. The microscope system as defined in claim 1, wherein the microscope is a scanning microscope (100).

5. The microscope system as defined in claim 4, wherein the scanning microscope is a confocal scanning microscope.

6. The microscope system as defined in claim 1, wherein the signature parameters encompass at least one statistical parameter of the signature interpreted as a distribution function, wherein the distribution function is mean or variance or moments or quartiles or skewness or median or maximum and minimum.

7. A method for detecting and compensating for changes within a recorded image content of a microscope specimen using a microscope, comprising the steps of:
a) scanning a specimen with an illuminating light beam and recording multiple image points for generation of a multidimensional image;
b) calculating signatures of the recorded multidimensional image;
c) calculating statistical signature parameters from the recorded signatures;
d) observing and ascertaining the changes in the statistical signature parameters; and
e) interpreting the changes in the signatures and converting them into signals for positioning motors or actuators that are provided in the microscope system.

8. The method as defined in claim 7, wherein the interpretation of the changes in the signatures, and the conversion into signals for positioning motors or actuators, are accomplished by means of a software module that records and observes changes in the signatures, derives signature parameters, and ascertains control signals from the signature parameters on the basis of an inference method.

9. The method as defined in claim 7, wherein changes in scan parameters can be determined from the ascertained signature parameters; and the scan parameters encompass image format, position of the XYZ stage, electronic zoom, objective change, galvanometer positions, and spectral scan bands.

10. The method as defined in claim 7, wherein the signature parameters encompass at least one statistical parameter of the signature interpreted as a distribution function, examples being mean, variance, moments, quartiles, skewness, median, maximum, and minimum.
